(19) United States
(12) Patent Application Publication
(10) Pub. No.: US 2026/0241800 A1
(43) Pub. Date: Aug. 20, 2026

(54) ELECTRIC VEHICLE CONTROL DEVICE AND ELECTRIC VEHICLE CONTROL SYSTEM

(71) Applicant: Mitsubishi Electric Corporation, Chiyoda-ku, Tokyo (JP)

(72) Inventor: Kosuke TOKITO, Chiyoda-ku, Tokyo (JP)

(73) Assignee: Mitsubishi Electric Corporation, Chiyoda-ku, Tokyo (JP)

(21) Appl. No.: 18/858,999

(22) PCT Filed: Jun. 21, 2022
(86) PCT No.: PCT/JP2022/024637

§ 371 Date: Oct. 22, 2024

(51) Int. Cl. B60L 3/04; B60L 3/00; H02M 7/537

(52) U.S. Cl. CPC B60L 3/04; B60L 3/003; H02M 7/537

(57) ABSTRACT

An electric vehicle control device includes a power converter mountable on an electric vehicle to receive power from a power supply and convert DC power to AC power, a breaker to switch between connection and disconnection of a current flowing between the power supply and the power converter, a first contactor connected in series to a resistor between the power converter and the breaker, and a second contactor connected in parallel to the resistor and the first contactor to switch between connection and disconnection of a current flowing between the power converter and the power supply. When the power converter charges a capacitor with power from the power supply by turning off the second contactor and turning on the breaker and the first contactor, the power converter turns on the second contactor after turning off the breaker to disconnect power from the power supply upon detecting an abnormality.

### TECHNICAL FIELD

The present disclosure relates to an electric vehicle control device that receives power from an external power supply and an electric vehicle control system.

### BACKGROUND ART

An electric vehicle converts, with an inverter, direct current (DC) power to three-phase alternating current (AC) power with a variable voltage and a variable frequency, and supplies the AC power to an electric motor or an auxiliary power supply. Patent Literature 1 describes a structure including a breaker, multiple inverters, multiple connection circuits, and a control unit. The multiple inverters receive power supplied through the breaker. The control unit turns off the breaker when an abnormality occurs in an AC circuit that is a combination of a connection circuit and an electric motor. The control unit then stops an inverter having the abnormality to electrically disconnect the AC circuit having the abnormality from the power feeding system.

### CITATION LIST

### Patent Literature

Patent Literature 1: Unexamined Japanese Patent Application Publication No. 2018-191487

### SUMMARY OF INVENTION

### Technical Problem

To allow the DC voltage to remain stable, the electric vehicle includes a filter capacitor connected in parallel to an input terminal, or a DC end, of each inverter. To prevent an inrush current from flowing through the filter capacitor charged upon activation of the electric vehicle, the amount of current flowing through the filter capacitor is reduced using a charging resistor until the voltage reaches a predetermined voltage. When an abnormality occurs during charging of the filter capacitor, the electric vehicle performs control to turn off the breaker and stop supplying power from the power supply. However, charging through the charging resistor causes a smaller amount of current to flow than charging without using the resistor. In this case, the breaker may not be turned off fully.

In response to the above issue, an objective of the present disclosure is to provide an electric vehicle control device that can turn off a breaker when a smaller amount of current is flowing than during charging without using a resistor.

To achieve the above objective, an electric vehicle control device according to an aspect of the present disclosure includes a power converter mountable on an electric vehicle to receive power from a power supply and convert direct current power to alternating current power, a breaker to switch between connection and disconnection of a current flowing between the power supply and the power converter, a first contactor connected in series to a resistor between the power converter and the breaker, and a second contactor connected in parallel to the resistor and the first contactor to switch between connection and disconnection of a current flowing between the power converter and the power supply. When the power converter charges a capacitor with power from the power supply by turning off the second contactor and turning on the breaker and the first contactor, the power converter turns on the second contactor after performing control to turn off the breaker to disconnect power from the power supply upon detecting an abnormality in the electric vehicle.

To achieve the above objective, an electric vehicle control system according to an aspect of the present disclosure includes a first electric vehicle control device and a second electric vehicle control device mountable on an electric vehicle, and a breaker to switch between connection and disconnection of a current flowing between a power supply and the first electric vehicle control device and a current flowing between the power supply and the second electric vehicle control device. Each of the first electric vehicle control device and the second electric vehicle control device includes a power converter to receive power from the power supply and convert direct current power to alternating current power, a first contactor connected in series to a resistor between the power converter and the breaker, and a second contactor connected in parallel to the resistor and the first contactor to switch between connection and disconnection of a current flowing between the power converter and the power supply. When each of the power converter in the first electric vehicle control device and the power converter in the second electric vehicle control device charges a capacitor with power from the power supply by turning off the second contactor and turning on the breaker and the first contactor, the power converter in the first electric vehicle control device performs control to turn off the breaker to disconnect power from the power supply upon detecting an abnormality in the first electric vehicle control device, and notifies the power converter in the second electric vehicle control device of the abnormality in the first electric vehicle control device, and the power converter in the second electric vehicle control device turns on the second contactor in the second electric vehicle control device upon being notified of the abnormality in the first electric vehicle control device by the power converter in the first electric vehicle control device.

### Advantageous Effects of Invention

The electric vehicle control device according to the aspect of the present disclosure includes the power converter mountable on an electric vehicle to receive power from the power supply and convert direct current power to alternating current power, the breaker to switch between connection and disconnection of the current flowing between the power supply and the power converter, the first contactor connected in series to the resistor between the power converter and the breaker, and the second contactor connected in parallel to the resistor and the first contactor to switch between connection and disconnection of the current flowing between the power converter and the power supply. When the power converter charges the capacitor with power from the power supply by turning off the second contactor and turning on the breaker and the first contactor, the power converter turns on the second contactor after performing control to turn off the breaker to disconnect power from the power supply upon detecting an abnormality in the electric vehicle. This structure enables the breaker to turn off when a smaller amount of current is flowing than during charging without using the resistor.

The electric vehicle control system according to the aspect of the present disclosure includes the first electric vehicle control device and the second electric vehicle control device mountable on an electric vehicle, and the breaker to switch between connection and disconnection of the current flowing between the power supply and the first electric vehicle control device and the current flowing between the power supply and the second electric vehicle control device. Each of the first electric vehicle control device and the second electric vehicle control device includes the power converter to receive power from the power supply and convert direct current power to alternating current power, the first contactor connected in series to the resistor between the power converter and the breaker, and the second contactor connected in parallel to the resistor and the first contactor to switch between connection and disconnection of the current flowing between the power converter and the power supply. When each of the power converter in the first electric vehicle control device and the power converter in the second electric vehicle control device charges the capacitor with power from the power supply by turning off the second contactor and turning on the breaker and the first contactor, the power converter in the first electric vehicle control device performs control to turn off the breaker to disconnect power from the power supply upon detecting an abnormality in the first electric vehicle control device, and notifies the power converter in the second electric vehicle control device of the abnormality in the first electric vehicle control device, and the power converter in the second electric vehicle control device turns on the second contactor in the second electric vehicle control device upon being notified of the abnormality in the first electric vehicle control device by the power converter in the first electric vehicle control device. This structure enables the breaker to turn off when a smaller amount of current is flowing than during charging without using the resistor.

### BRIEF DESCRIPTION OF DRAWINGS

FIG. 1 is a block diagram of an electric vehicle control device according to Embodiment 1;

FIG. 2 is a block diagram of a power converter in Embodiment 1;

FIG. 3 is a sequence diagram of an example operation of the electric vehicle control device according to Embodiment 1;

FIG. 4 is a block diagram of an electric vehicle control system according to Embodiment 2;

FIG. 5 is a sequence diagram of an example operation of the electric vehicle control system according to Embodiment 2; and

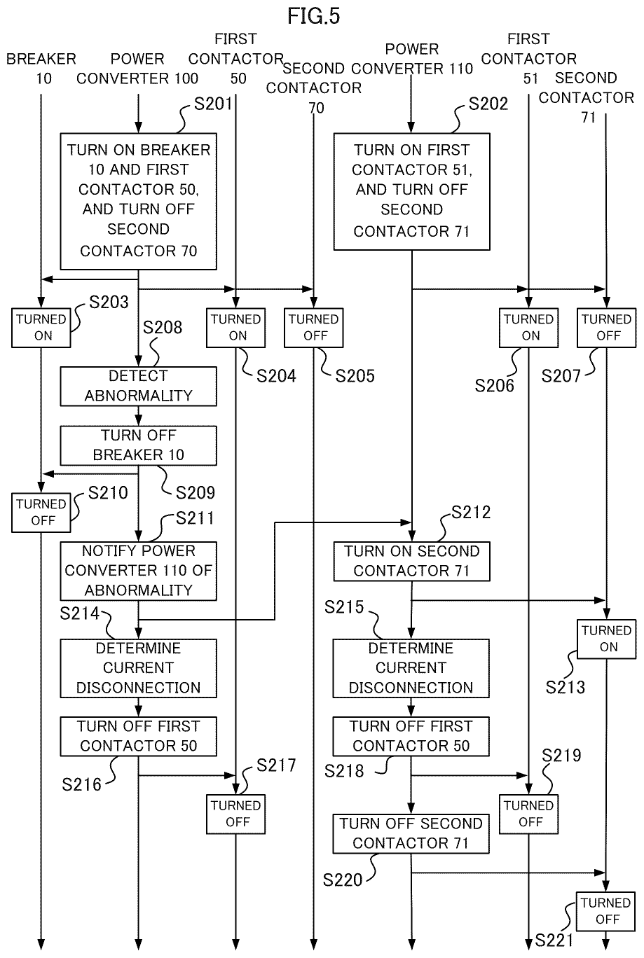

FIG. 6 is a diagram of an electric vehicle control system according to one or more embodiments, illustrating the typical hardware configuration.

### DESCRIPTION OF EMBODIMENTS

An electric vehicle control system according to one or more embodiments of the present disclosure is described with reference to the drawings.

The same reference numerals denote components having substantially the same functions herein and in the drawings, and such components are not described repeatedly. In the drawings, the structures of the circuits and devices are schematic.

### Embodiment 1

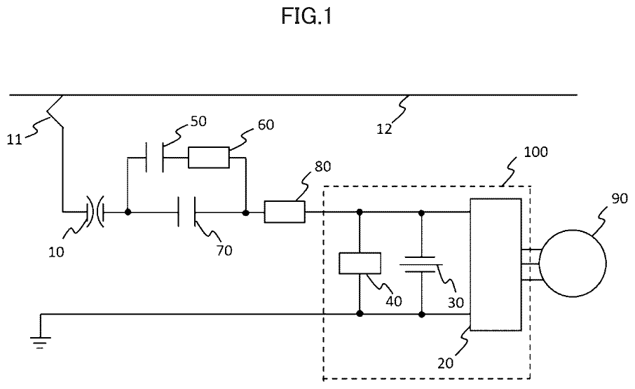

FIG. 1 is a block diagram of an electric vehicle control device according to Embodiment 1 of the present disclosure. In FIG. 1, the electric vehicle control device includes a breaker 10, a first contactor 50, a resistor 60, a second contactor 70, and a power converter 100. The power converter 100 converts power supplied from a power supply 12 to direct current (DC) power or alternating current (AC) power and supplies the resultant power to a load 90. The load is, for example, an electric motor. The power converter 100 includes an inverter 20, a filter capacitor 30, and a voltage detector 40. The inverter 20 is, for example, a two-level three-phase inverter circuit or a three-level three-phase inverter circuit.

The breaker 10 is electrically connected in series between a current collector 11 and the power converter 100. The breaker 10 has one end connected to the current collector 11 and the other end connected to the first contactor 50 and the second contactor 70. The first contactor 50 has one end connected to the breaker 10 and the other end connected to the resistor 60. The first contactor 50 and the resistor 60 are connected in series. The second contactor 70 has one end connected to the breaker 10 and the other end connected to the resistor 60 and a filter reactor 80. The second contactor 70 and the resistor 60 are connected in parallel. The resistor 60 has one end connected to the first contactor 50 and the other end connected to the second contactor 70 and the filter reactor 80. The filter reactor 80 has one end connected to the second contactor 70 and the resistor 60, and the other end connected to an input terminal of the inverter 20, the filter capacitor 30, and the voltage detector 40. The filter capacitor 30 has one end connected to the inverter 20, the voltage detector 40, and the filter reactor 80, and the other end grounded. The inverter 20 has one input terminal connected to the filter capacitor 30, the voltage detector 40, and the filter reactor 80, and the other input terminal grounded. The inverter 20 has an output terminal connected to the electric motor 90 serving as a load. The electric motor 90 is, for example, an induction motor, a synchronous motor, or a reluctance motor. The inverter 20 is connected in parallel to the filter capacitor 30 and the voltage detector 40.

The breaker 10 is turned off to stop power supply to the electric vehicle when, for example, a fault occurs in the power converter 100. The breaker 10 is turned off to electrically disconnect the current collector 11 and the power converter 100, thus stopping power supply from the current collector 11 to the power converter 100. To supply power to the electric vehicle, the breaker 10 is turned on. The breaker 10 is turned on to electrically connect the current collector 11 and the power converter 100, thus starting power supply from the power supply 12 to the power converter 100.

The current collector 11 acquires, through the power supply 12, DC power from a transformer substation (not illustrated) as an external circuit, and supplies the power to the power converter 100. The current collector 11 is, for example, a pantograph that receives power from an overhead power line or a current collector shoe that receives power from a third rail.

The power supply 12 is connected to the transformer substation to receive DC power from the transformer substation. The power supply 12 is, for example, an overhead power line or a third rail.

Each of the first contactor 50 and the second contactor 70 has both ends electrically connected when turned on, and electrically disconnected when turned off. The resistor 60 is a charging resistor used to prevent an inrush current from flowing when the filter capacitor 30 is charged. The filter reactor 80 and the filter capacitor 30 are included in an inductor-capacitor (LC) filter circuit to reduce harmonics generated and flowing through the power supply 12 in power conversion performed by the inverter 20. The filter reactor 80 smooths the current flowing from the power supply 12 to the inverter 20. The filter capacitor 30 smooths the voltage at the DC end of the inverter 20. The inverter 20 converts the DC power supplied from the power supply 12 to AC power, and supplies the resultant AC power to the electric motor 90.

The breaker 10 and the first contactor 50 are turned on to supply power to the power converter 100. In this state, the second contactor 70 is off. When the breaker 10 and the first contactor 50 are turned on, the current collector 11, the breaker 10, the first contactor 50, the resistor 60, the filter reactor 80, and the filter capacitor 30 are electrically connected to charge the filter capacitor 30. When the filter capacitor 30 is charged with a predetermined amount of electric power, the second contactor 70 is turned on, and the first contactor 50 is turned off. When the second contactor 70 is turned on and the first contactor 50 is turned off, the current collector 11, the breaker 10, the second contactor 70, the filter reactor 80, and the filter capacitor 30 are electrically connected to charge the filter capacitor 30. The filter capacitor 30 is charged through the first contactor 50 and the resistor 60 to reduce an inrush current flowing through the filter capacitor 30. To prevent an inrush current from flowing when the filter capacitor 30 is charged, the first contactor 50 and the second contactor 70 are turned on in a switchable manner. When the filter capacitor 30 is charged, the inverter 20 can perform power conversion. The power conversion operation is a typical operation and is not described.

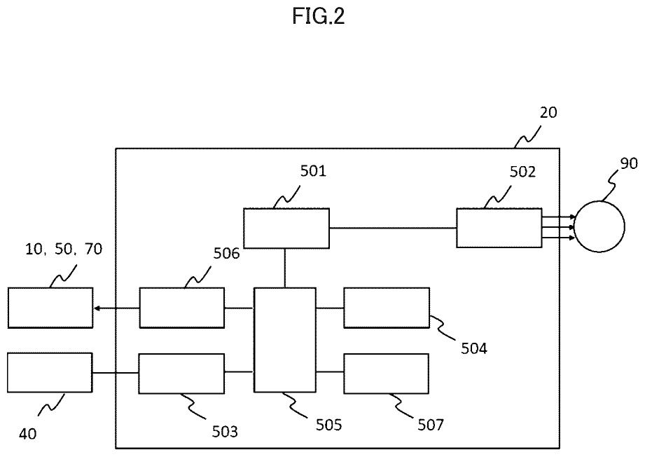

FIG. 2 is a schematic diagram of a power converter in Embodiment 1 of the present disclosure. The inverter 20 is described as an example. The inverter 20 includes a drive 501, a conversion unit 502, an abnormality detector 504, a communicator 503, a processing unit 505, a control unit 506, and a storage 507.

The drive 501 controls switching elements included in the conversion unit 502. More specifically, the drive 501 generates a signal for controlling the gate of each switching element that is a transistor.

The conversion unit 502 includes the switching elements included in a two-level three-phase inverter circuit. The switching elements each include a pair of a positive arm and a negative arm connected in series. These arms are referred to as legs. The conversion unit 502 has legs for each of the U-phase, V-phase, and W-phase. The conversion unit 502 converts DC power to AC power. The conversion unit 502 supplies the resultant AC power to the electric motor 90.

The communicator 503 receives a value input from the voltage detector 40. The value of the voltage detector 40 indicates the voltage value of the filter capacitor 30.

The abnormality detector 504 detects a fault in the electric vehicle control device. The fault may be, for example, an abnormality in charging, or specifically, a failure to charge the filter capacitor 30 with a predetermined amount of electric power in a predetermined period, or may be a short circuit in the electric vehicle control device. When the value of the voltage detector 40 satisfies a fault condition stored in the storage 507, the abnormality detector 504 determines that the electric vehicle control device is abnormal. For example, the abnormality detector 504 determines that the charging is abnormal when the value of the voltage detector 40 does not reach the predetermined value after the predetermined period stored in the storage 507.

The processing unit 505 is connected to the communicator 503 to receive a value input from the voltage detector 40. The processing unit 505 also transmits, to the control unit 506, a command for turning on or off the breaker 10, the first contactor 50, and the second contactor 70.

Upon receiving a command transmitted from the processing unit 505 for turning on or off the breaker 10, the first contactor 50, and the second contactor 70, the control unit 506 performs control to turn on or off the breaker 10, the first contactor 50, and the second contactor 70.

The storage 507 is a memory storing fault conditions. More specifically, the storage 507 stores conditions used by the abnormality detector 504 to detect a fault.

The structure of the breaker 10 is described. The breaker 10 is, for example, a magnetic circuit breaker. When the current flowing through an electric circuit is forcibly disconnected, the current tends to flow continuously through the electric path, causing an arc discharge between the electrodes that are physically separate from each other. The arc discharge is conductive, and thus causes the current to continuously flow through the arc discharge. A magnetic circuit breaker attracts, with an electromagnetic force, an arc discharge generated when a current is disconnected, and guides the arc discharge to an arc chute. However, the electromagnetic force is smaller when a smaller amount of current flows. This may result in the arc not being fully guided to the arc chute, leading to incomplete disconnection.

When, for example, the filter capacitor 30 in the electric vehicle control device is charged, the second contactor 70 is turned off and the first contactor 50 connected in series to the resistor 60 is turned on to reduce the current flowing through the filter capacitor 30. When the power converter 100 detects an abnormality such as a failure to charge the filter capacitor 30 or a short circuit in the electric vehicle control device, the power converter 100 is to disconnect the breaker 10. However, the breaker 10 may not be disconnected when a small amount of current is flowing. In one or more embodiments of the present disclosure, the breaker 10 can be turned off with a smaller amount of current. In one or more embodiments of the present disclosure, a smaller amount of current flowing refers to a smaller amount of current flowing in charging through the resistor 60 than in charging without using the resistor 60.

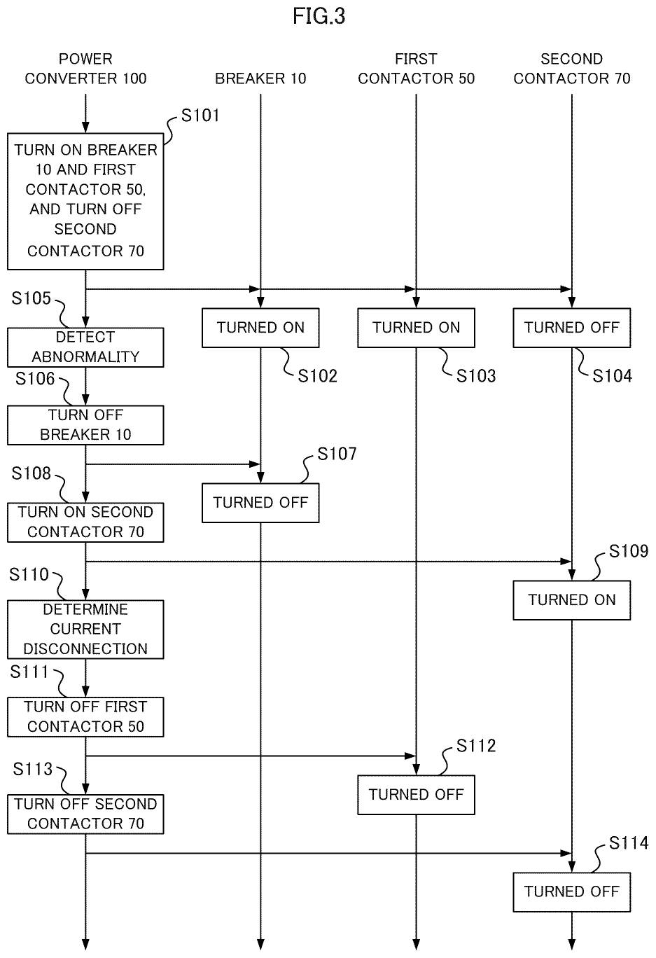

The operation of the electric vehicle control device according to Embodiment 1 of the present disclosure is described below. FIG. 3 is a sequence diagram of example operations of the power converter 100, the breaker 10, the first contactor 50, and the second contactor 70 in the electric vehicle control device according to Embodiment 1 of the present disclosure when an abnormality such as a short circuit or an abnormality in charging occurs during charging of the filter capacitor 30.

To charge the filter capacitor 30, the control unit 506 in the power converter 100 performs control to turn on the breaker 10, turn on the first contactor 50, and turn off the second contactor 70 (S101). The breaker 10 is turned on (S102), the first contactor 50 is turned on (S103), and the second contactor 70 is turned off (S104). The abnormality detector 504 in the power converter 100 detects an abnormality such as a short circuit in the electric vehicle control device or an abnormality in charging (S105). The control unit 506 in the power converter 100 performs control to turn off the breaker 10 (S106). The breaker 10 is turned off (S107). After the breaker 10 is turned off, the control unit 506 in the power converter 100 performs control to turn on the second contactor 70 (S108). The second contactor 70 is turned on (S109). The second contactor 70 is turned on to temporarily increase the amount of current flowing through the breaker 10. Increasing the amount of current flowing through the breaker 10 increases the electromagnetic force in the breaker 10. This allows the arc discharge to be guided to the arc chute to disconnect the current. The power converter 100 determines, with a current detector (not illustrated) or a voltage detector (not illustrated), that the current flowing through the electric vehicle control device is disconnected (S110). After determining that the current flowing through the electric vehicle control device is disconnected, the control unit 506 in the power converter 100 performs control to turn off the first contactor 50 (S111). The first contactor 50 is turned off (S112). The control unit 506 in the power converter 100 finally performs control to turn off the second contactor 70 (S113). The second contactor 70 is turned off (S114).

When the electric vehicle control device detects an abnormality such as a short circuit in the electric vehicle control device or an abnormality in charging during charging of the filter capacitor 30, the electric vehicle control device first turns off the breaker 10 and then turns on the second contactor 70 to increase the amount of current flowing through the breaker 10 and disconnect the current flowing through the breaker 10.

The current in an amount increased by turning on the second contactor 70 flows through the short-circuited portion, the filter capacitor 30, or a discharging circuit (not illustrated). The current in an amount increased by turning on the second contactor 70 may flow through other means.

After determining that no current is flowing through the electric vehicle control device, or in other words, determining that the current flowing through the electric vehicle control device is disconnected, the electric vehicle control device turns off the first contactor 50. More specifically, the electric vehicle control device determines whether the current flowing through the electric vehicle control device is disconnected when a predetermined period elapses after turning on the second contactor 70. The electric vehicle control device then turns off the first contactor 50 when a predetermined period elapses after determining that the current flowing through the breaker is disconnected.

As described above, upon detecting an abnormality such as a short circuit in the electric vehicle control device or an abnormality in charging when a smaller amount of current is flowing during, for example, charging of the filter capacitor 30, the electric vehicle control device first turns off the breaker 10 and then turns on the second contactor 70 to temporarily increase the amount of current flowing through the breaker 10 and thus to increase the electromagnetic force in the breaker 10 to disconnect the current flowing through the breaker 10. In other words, the electric vehicle control device can turn off the breaker 10 when a smaller amount of current is flowing than during charging without using the resistor.

The electric vehicle control device according to Embodiment 1 includes the power converter mountable on an electric vehicle to receive power from the power supply and convert direct current power to alternating current power, the breaker to switch between connection and disconnection of the current flowing between the power supply and the power converter, the first contactor connected in series to the resistor between the power converter and the breaker, and the second contactor connected in parallel to the resistor and the first contactor to switch between connection and disconnection of the current flowing between the power converter and the power supply. When the power converter charges the capacitor with power from the power supply by turning off the second contactor and turning on the breaker and the first contactor, the power converter turns on the second contactor after performing control to turn off the breaker to disconnect power from the power supply upon detecting an abnormality in the electric vehicle.

This structure enables the breaker to turn off when a smaller amount of current is flowing than during charging without using the resistor.

### Embodiment 2

In Embodiment 1, the current in an amount temporarily increased by turning on the second contactor 70 flows through the electric vehicle control device having an abnormality to allow a sufficient amount of current to flow. In Embodiment 2, when a smaller amount of current is flowing than during charging without using the resistor, the breaker 10 can be turned off by causing a current to flow through an electric vehicle control device without an abnormality, selectively from multiple electric vehicle control devices mounted on the same vehicle or in the same carriage.

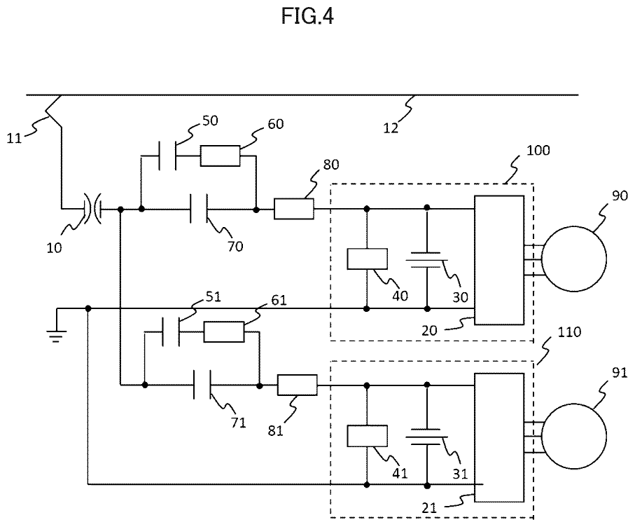

FIG. 4 is a block diagram of an electric vehicle control system according to Embodiment 2 of the present disclosure. In FIG. 2, a first electric vehicle control device includes a breaker 10, a first contactor 50, a resistor 60, a second contactor 70, and a power converter 100. A second electric vehicle control device includes the breaker 10, a first contactor 51, a resistor 61, a second contactor 71, and a power converter 110. The breaker 10 is common to the first electric vehicle control device and the second electric vehicle control device.

A basic operation for charging a filter capacitor 30 in the power converter 100 included in the first electric vehicle control device and a filter capacitor 31 in the power converter 110 included in the second electric vehicle control device is the same as the operation described in Embodiment 1. The breaker 10 is turned on, the first contactor 50 is turned on, and the second contactor 70 is turned off to start charging the filter capacitor 30 in the first electric vehicle control device. The first contactor 51 is turned on and the second contactor 71 is turned off to start charging the filter capacitor 31 in the second electric vehicle control device.

The operation described below is performed upon detecting an abnormality in the first electric vehicle control device during charging of the filter capacitor 30 in the power converter 100 included in the first electric vehicle control device and the filter capacitor 31 in the power converter 110 included in the second electric vehicle control device.

To charge the filter capacitor 30, the control unit 506 in the power converter 100 performs control to turn on the breaker 10, turn on the first contactor 50, and turn off the second contactor 70 (S201). The control unit 506 in the power converter 110 also performs control to turn on the first contactor 51 and turn off the second contactor 71 to charge the filter capacitor 31 (S202). The breaker 10 is turned on (S203), the first contactor 50 is turned on (S204), and the second contactor 70 is turned off (S205). The first contactor 51 is turned on (S206), and the second contactor 71 is turned off (S207). The abnormality detector 504 in the power converter 100 detects an abnormality such as a short circuit in the electric vehicle control device or an abnormality in charging (S208). The control unit 506 in the power converter 100 performs control to turn off the breaker 10 (S209). The breaker 10 is turned off (S210). After the breaker 10 is turned off, the communicator 503 in the power converter 100 notifies the communicator 503 in the power converter 110 of the abnormality in the first electric vehicle control device (S211). After being notified of the abnormality in the first electric vehicle control device, the control unit 506 in the power converter 110 performs control to turn on the second contactor 71 (S212). The second contactor 71 is turned on (S213). The second contactor 71 is turned on to temporarily increase the current flowing through the breaker 10. Increasing the amount of current flowing through the breaker 10 increases the electromagnetic force in the breaker 10. This allows the arc discharge to be guided to the arc chute to disconnect the current. The power converter 100 and the power converter 110 determine that the current flowing through the first electric vehicle control device and the second electric vehicle control device is disconnected (S214 and S215). After determining that the current flowing through each electric vehicle control device is disconnected, the control unit 506 in the power converter 100 performs control to turn off the first contactor 50 (S216). The first contactor 50 is turned off (S217). The control unit 506 in the power converter 110 performs control to turn off the first contactor 51 (S218). The first contactor 51 is turned off (S219). The control unit 506 in the power converter 110 finally performs control to turn off the second contactor 71 (S220). The second contactor 71 is turned off (S221).

In the electric vehicle control system, when the power converter 100 in the first electric vehicle control device detects an abnormality such as a short circuit in the first electric vehicle control device or an abnormality in charging during charging of the filter capacitor 30 in the first electric vehicle control device, the power converter 100 in the first electric vehicle control device first turns off the breaker 10, and the power converter 110 in the second electric vehicle control device then turns on the second contactor 71 in the second electric vehicle control device to increase the amount of current flowing through the breaker 10 to disconnect the current flowing through the breaker 10.

The current in an amount temporarily increased by turning on the second contactor 71 in the second electric vehicle control device flows through the filter capacitor 31 in the second electric vehicle control device or through a discharging circuit (not illustrated) in the second electric vehicle control device. The current in an amount temporarily increased by turning on the second contactor 71 may flow through other means.

The first electric vehicle control device determines that no current is flowing through the first electric vehicle control device with a current detector (not illustrated) or a voltage detector (not illustrated), and then turns off the first contactor 50. The second electric vehicle control device also determines that no current is flowing through the second electric vehicle control device with a current detector (not illustrated) or a voltage detector (not illustrated), and then turns off the first contactor 51.

As described above, upon detecting an abnormality such as a short circuit in the electric vehicle control device or an abnormality in charging when a smaller amount of current is flowing during, for example, charging of the filter capacitor 30 and the filter capacitor 31, the electric vehicle control system first turns off the breaker 10 and then turns on the second contactor 71 to temporarily increase the amount of current flowing through the breaker 10 and thus to increase the electromagnetic force in the breaker 10 to disconnect the current flowing through the breaker 10. In other words, the electric vehicle control system can turn off the breaker 10 when a smaller amount of current is flowing than during charging without using the resistor.

As described above, in the electric vehicle control system, the first electric vehicle control device notifies the second electric vehicle control device of an abnormality in the first electric vehicle control device, and the second electric vehicle control device notified of the abnormality in the first electric vehicle control device can control the electric vehicle control system.

As described above, the electric vehicle control system turns on the second contactor 71 in the second electric vehicle control device without an abnormality to prevent a current from flowing through the first electric vehicle control device with an abnormality.

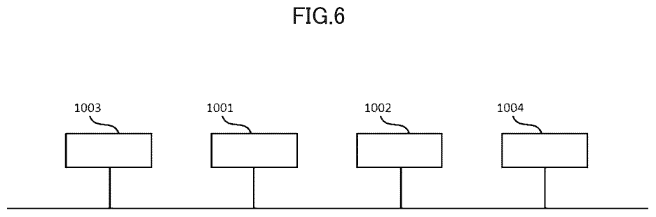

The power converter 100 and the power converter 110 each include at least a processor, a memory, a receiver, and a transmitter. The operation of each of the power converter 100 and the power converter 110 may be implemented using software. FIG. 6 is a diagram of an electric vehicle control device and an electric vehicle control system according to one or more embodiments, illustrating the typical hardware configuration. The controller illustrated in FIG. 6 includes a processor 1001, a memory 1002, a receiver 1003, and a transmitter 1004. The processor 1001 performs, with software, computation and control using received data. The memory 1002 stores the received data or data used by the processor 1001 for computation and control. The memory 1002 also stores the software. The receiver 1003 is an interface for receiving signals or information input into the power converter 100 and the power converter 110. The transmitter 1004 is an interface for transmitting signals or information output from the power converter 100 and the power converter 110. The controller may include multiple processors 1001, multiple memories 1002, multiple receivers 1003, and multiple transmitters 1004.

Although the power supply is DC power supply in the above embodiments, the power supply may be AC power supply. When the power supply is AC power supply, a transformer is installed subsequent to the current collector 11 to lower a received AC voltage, and a converter is installed subsequent to the transformer to convert the AC voltage output from the transformer to a DC voltage.

Although the power converter 100 and the power converter 110 have electric motors as loads in the above embodiments, the loads may be auxiliary power supplies. The breaker 10 may be common to the electric motors and the auxiliary power supplies.

In the above embodiments, the power converter 100 performs control to turn off the breaker 10. In some embodiments, the power converter 100 may notify the power converter 110 of an abnormality in the first electric vehicle control device, and the power converter 110 notified of the abnormality in the first electric vehicle control device by the power converter 100 may perform control to turn off the breaker 10.

The electric vehicle control system according to Embodiment 2 includes the first electric vehicle control device and the second electric vehicle control device mountable on an electric vehicle, and the breaker to switch between connection and disconnection of the current flowing between the power supply and the first electric vehicle control device and the current flowing between the power supply and the second electric vehicle control device. Each of the first electric vehicle control device and the second electric vehicle control device includes the power converter to receive power from the power supply and convert direct current power to alternating current power, the first contactor connected in series to the resistor between the power converter and the breaker, and the second contactor connected in parallel to the resistor and the first contactor to switch between connection and disconnection of the current flowing between the power converter and the power supply. When each of the power converter in the first electric vehicle control device and the power converter in the second electric vehicle control device charges the capacitor with power from the power supply by turning off the second contactor and turning on the breaker and the first contactor, the power converter in the first electric vehicle control device performs control to turn off the breaker to disconnect power from the power supply upon detecting an abnormality in the first electric vehicle control device, and notifies the power converter in the second electric vehicle control device of the abnormality in the first electric vehicle control device, and the power converter in the second electric vehicle control device turns on the second contactor in the second electric vehicle control device upon being notified of the abnormality in the first electric vehicle control device by the power converter in the first electric vehicle control device. This structure enables the breaker to turn off when a smaller amount of current is flowing than during charging without using the resistor.

### REFERENCE SIGNS LIST

10 Breaker
11 Current collector
12 Power supply
20, 21 Inverter
30, 31 Filter capacitor
40, 41 Voltage detector
50, 51 First contactor
60, 61 Resistor
70, 71 Second contactor
80, 81 Filter reactor
90, 91 Electric motor
100, 110 Power converter
501 Drive
502 Conversion unit
503 Communicator
504 Abnormality detector
505 Processing unit
506 Control unit
507 Storage
1001 Processor
1002 Memory
1003 Receiver
1004 Transmitter

1. An electric vehicle control device, comprising:
a power converter mountable on an electric vehicle and configured to receive power from a power supply and convert direct current power to alternating current power;
a breaker to switch between connection and disconnection of a current flowing between the power supply and the power converter;
a first contactor connected in series to a resistor between the power converter and the breaker; and
a second contactor connected in parallel to the resistor and the first contactor and configured to switch between connection and disconnection of a current flowing between the power converter and the power supply,
wherein when the power converter charges a capacitor with power from the power supply by turning off the second contactor and turning on the breaker and the first contactor, the power converter turns on the second contactor after performing control to turn off the breaker to disconnect power from the power supply upon detecting an abnormality in the electric vehicle.

2. An electric vehicle control system, comprising:
a first electric vehicle control device and a second electric vehicle control device mountable on an electric vehicle; and
a breaker to switch between connection and disconnection of a current flowing between a power supply and the first electric vehicle control device and a current flowing between the power supply and the second electric vehicle control device,
wherein each of the first electric vehicle control device and the second electric vehicle control device includes
a power converter to receive power from the power supply and convert direct current power to alternating current power,
a first contactor connected in series to a resistor between the power converter, and
a second contactor connected in parallel to the resistor and the first contactor and configured to switch between connection and disconnection of a current flowing between the power converter and the power supply, and
when each of the power converter in the first electric vehicle control device and the power converter in the second electric vehicle control device charges a capacitor with power from the power supply by turning off the second contactor and turning on the breaker and the first contactor,
the power converter in the first electric vehicle control device performs control to turn off the breaker to disconnect power from the power supply upon detecting an abnormality in the first electric vehicle control device, and notifies the power converter in the second electric vehicle control device of the abnormality in the first electric vehicle control device, and
the power converter in the second electric vehicle control device turns on the second contactor in the second electric vehicle control device upon being notified of the abnormality in the first electric vehicle control device by the power converter in the first electric vehicle control device.
